(19) United States
(12) Patent Application Publication
(10) Pub. No.: US 2023/0294930 A1
(43) Pub. Date: Sep. 21, 2023

(54) HANDLING PLANT AND HANDLING METHOD FOR PRODUCT CONTAINERS

(71) Applicant: KRONES AG, Neutraubling (DE)

(72) Inventors: Janet Denise WILCZEK, Regensburg (DE); Maximilian WEINZIERL, Regensburg (DE); Katarina MEHRINGER, Regensburg (DE); Gala GEIGER, Dachau (DE); Christoph Maximilian STEMPLINGER, Regensburg (DE); Manfred ZIEGLER, Passau (DE); Matthias HOTTER, Regensburg (DE)

(21) Appl. No.: 18/006,535

(22) PCT Filed: Jul. 5, 2021
(86) PCT No.: PCT/EP2021/068496

§ 371 Date: Jan. 23, 2023

(30) Foreign Application Priority Data
Aug. 28, 2020 (DE) 10 2020 122 573.3

(51) Int. Cl. B65G 43/00; B29C 49/42; H04B 5/00

(52) U.S. Cl. CPC B65G 43/00; B29C 49/42069; H04B 5/0062; B65G 2201/0235; B65G 2207/08; B65G 2203/0266; B29C 49/10

(57) ABSTRACT

The invention relates to a handling system for product containers, having a transporter for transporting the product containers and having at least one container handling machine which comprises a handling assembly for handling the product containers, wherein the container handling machine comprises a plurality of interchangeable fitting parts for processing different product types and receptacle locations provided therefor, and wherein the interchangeable fitting parts comprise first data transponders having first identification data for identification, wherein the handling system comprises a line management system which, for processing the different product types, is designed to provide to the at least one container handling machine a production order having a configuration list in each case, wherein the configuration list comprises a selection of the interchangeable fitting parts provided for the processing of the particular product types, and wherein the handling system comprises a reader.

The invention relates to a handling plant and a handling method for product containers with the features of the preamble of claims 1 and 11, respectively.

Typically, such handling plants comprise a conveyor for transporting the product containers and at least one container handling machine with a handling unit for handling the product containers. Since such handling plants are often used to process different product types, for example different beverages and/or container types, the at least one container handling machine is equipped with several interchangeable kit parts for processing them. For this purpose, receiving points are provided at which a first selection of the kit parts for a first product type is arranged. When a change to a second product type is performed, the first selection is replaced by a second selection of kit parts.

Usually, such interchangeable kit parts are provided with visual markings, which are then assigned by the operator to the relevant product type. Since the operator does not receive any feedback as to whether the respective kit part actually fits the intended product type, it can happen in rare cases that the wrong kit parts are installed or that their position or orientation is incorrect. This can damage the at least one container handling machine when handling the product containers.

From EP 2332846 A1 a device and a method for handling of containers with kit recognition are known, wherein a first transmitting device is arranged stationary on a format part of the device and a second transmitting device is arranged stationary on the device in order to determine from the emitted signals whether the format part is in a predetermined position relative to the device. In doing so, the first transmitting device emits a signal that is characteristic for the relevant format part.

The disadvantage here is that only after the relevant format part has been installed with the receiving device, it can be determined on the basis of a comparison of the signals from the first transmitting device on the format part and the second transmitting device on the device whether the corresponding format part has been correctly arranged.

It is therefore the object of the present invention to provide a handling plant for product containers in which the interchangeable kit parts can be installed more quickly and reliably.

To solve this object, the invention provides a handling plant for product containers with the features of claim 1. Advantageous embodiments of the invention are specified in the subclaims.

Since the handling plant comprises the line management system, which may represent a higher-level control unit of the handling plant and, for the processing of the different product types, is configured to provide in each case the production order with the configuration list of the at least one container handling machine, the configuration list comprising the selection of interchangeable kit parts intended for the processing of the respective product type, the kit parts required for the respective production order are automatically provided as information. The fact that the handling plant comprises the reader, which can be attached to the arm or hand of the operator, for reading the first identification data from the first data transponders enables the operator to easily identify the selection of interchangeable kit parts provided in the configuration list by reading the first data transponders of the kit parts with the reader. This can be done, for example, with an inventory of at least some of the interchangeable kit parts. As a result, the operator already knows when picking up one of the kit parts from the inventory that it belongs to the intended selection and is therefore required for the corresponding production order. The fact that the reader can be attached to the arm or hand of the operator means that the operator can still pick up the kit parts with both hands without having to use the reader in one hand.

Thus the handling plant according to the invention makes it possible to install the interchangeable kit parts quickly and reliably.

The handling plant may be configured to produce the product containers, to clean them, to fill a fluid product, in particular a beverage, into the product containers, to subsequently close and/or pack the filled product containers. In particular, the plant may be a beverage processing plant. The at least one container handling machine may comprise a container production machine (for example a stretch blow molding machine), a cooling device, a rinser, a labelling machine, a direct printing machine, a filler, a sealer and/or a packaging machine for the product containers. “Handling of the product containers” may include manufacturing, cleaning, labelling, printing, filling, sealing and/or packaging the product containers. The at least one container handling machine may be a single container handling machine or comprise multiple container handling machines.

The product containers may be configured to receive beverages, food, hygiene products, pastes, chemical, biological and/or pharmaceutical products. In particular, the product containers may be configured to receive a fluid product, for example a beverage. The product containers may be plastic bottles, glass bottles, cans and/or tubes. Product containers made of plastic may be in particular PET, PEN, HD-PE or PP containers or bottles. In particular, the product containers may be bottles. The product containers may be configured as biodegradable containers or bottles whose main components consist of renewable raw materials, such as sugar cane, wheat or maize.

The different types of products may be different types of drinks such as soft drinks, mineral water, beer and/or wine. However, this may also include any other different types of fluid products.

The conveyor may comprise a linear conveyor and/or a carousel conveyor. It is conceivable that the conveyor is assigned to the at least one container handling machine in order to transport the containers intermittently or continuously during handling. For example, the handling units may be arranged on the conveyor in order to handle the product containers arranged on the conveyor. For example, the at least one container handling machine may be a labelling machine with a carousel as the conveyor and with a labelling unit as the handling unit. The labelling unit can be arranged circumferentially on the carousel. However, it is also conceivable that the handling plant comprises several container handling machines, in particular with at least two of them being connected via the conveyor. The conveyor may comprise container receptacles to receive the product containers during transport and/or handling. It is conceivable that the container receptacles are configured with a centering bell and/or a turntable in order to rotate the product containers, for example during the application of a label.

The handling unit for handling the containers may comprise a blowing mould with a blowing nozzle, a cooling unit, a cleaning nozzle, a labelling unit, a pressure unit, a filling valve, a seaming chuck and/or a packaging unit for the product containers. The interchangeable kit parts may mean any machine parts that are configured to be interchangeable on the at least one container handling machine in order to adapt it to the processing of the different product types. For example, they may comprise a replaceable guide, a replaceable blowing mould and/or blowing nozzle, a dividing screw, a head of a filling valve and/or a seaming chuck or the like. The receiving points may be mechanical receptacles, holders and/or attachment points for the interchangeable kit parts.

The at least one container handling machine may comprise a machine control to control the handling unit and optionally the conveyor.

A “data transponder” may be an electronic unit with a memory for the first or second identification data and with an antenna for receiving and/or transmitting electromagnetic signals. The antenna may, for example, be configured as a dipole or as an induction coil to receive and/or issue the electromagnetic signals. This may refer to the first data transponders and/or the second data transponders.

The reader may be compatible with the first and/or second data transponders in such a way that the first and second identification data respectively can be read via the electromagnetic signals. It is conceivable that the first and/or second data transponders have their own energy supply or that they are supplied with energy via the reader during reading. In particular, the first and/or second data transponders may be RFID transponders and the reader may be an RFID reader. “Identification data” may include a unique identifier for the respective kit part or the respective receiving point, for example a unique sequence of letters and/or numbers. The fact that the reader is “attachable to the arm or hand of the operator” may include here that it comprises at least a part of a garment, for example at least a part of a glove or wristband. The reader may comprise an antenna for receiving and/or transmitting the electromagnetic signals, reading electronics, a memory for storing the read-out first or second identification data, a processing unit for processing the read-out first or second identification data and/or a data link for forwarding the read-out first or second identification data to the machine control of the at least one container handling machine or to the line management system.

The line management system may be connected to the at least one container handling machine via a data link, for example to the machine control. The line management system may be configured as a control unit on a higher level than the handling plant. The data connection may be configured as a physical data line or as a radio data connection. The line management system may be configured to configure the conveyor and/or the at least one container handling machine based on the production order with the configuration list. In other words, the line management system may be a higher-level control unit of the handling plant. The line management system may comprise a computer program product with machine instructions. The computer program product may comprise machine instructions which, when executed, cause the line management system to generate the production order with the configuration list of the at least one container handling machine based on the different product types, respectively. A configuration list may be a data table or a data file containing the selection of interchangeable kit parts intended for the processing of the respective product type, for example their first identification data.

It is conceivable that the at least one container handling machine comprises a machine control, wherein the machine control is configured to compare the first identification data with the configuration list in order to preset and/or check a correct equipment of the at least one container handling machine with the selection of the interchangeable kit parts of the operator provided for the corresponding product type. This allows the reader to have a particularly simple design, as the actual processing of the read identification data is carried out with the machine control. The machine control can be connected to the reader and/or the line management system via a data link. For example, the machine control may be connected to the line management system and/or the reader via a computer network, such as Ethernet and/or OPC UA (Open Platform Communications Unified Architecture) or the like.

It is conceivable that the configuration list comprises an assignment of the selection of the interchangeable kit parts to the respective receiving points of the at least one container handling machine provided for this purpose. This makes it particularly easy for the operator to assign the kit parts to their intended location and arrange them there.

The receiving points each comprise second data transponders with second identification data for identification purposes, in particular second RFID transponders, wherein the reader is configured to read the second identification data from the second data transponders. This also allows the operator to use the reader to identify the receiving points and check, for example, whether the assignment of the respective kit part is correct. It is conceivable that the operator uses the reader to identify one of the interchangeable kit parts from the intended selection by reading the first identification data from the first data transponder and then uses the reader to read the second identification data from the second data transponder of the receiving point, thereby ensuring that the kit part is assigned to the receiving point. This makes it particularly easy to ensure that the corresponding kit part belongs to the receiving point. If the assignment is correct, the operator can attach the kit part to the receiving point.

The machine control may be configured to compare the first identification data and the second identification data with the assignment in order to check a correct equipment of the receiving points with the selection of the interchangeable kit parts provided for the corresponding product type. This makes it particularly easy to automatically ensure that the respective kit part belongs to the corresponding receiving point. It is conceivable that the machine control and/or the reader are configured to issue a confirmation signal and/or an error signal if the assignment is correct or incorrect.

The receiving points may be at least partially equipped with a sensor to detect the presence of one of the interchangeable kit parts, its correct positioning and/or its correct orientation. This makes it possible to automatically ensure that one of the interchangeable kit parts is provided at the receiving point, correctly positioned and/or oriented. It is conceivable that the sensor is connected to the machine control and/or the line management system, for example via an electrical line. The sensor may be configured to provide an analogue and/or digital signal for the machine control and/or line management system to communicate the presence of one of the interchangeable kit parts, its correct positioning and/or its correct orientation.

The sensor may comprise a piezoelectric element to detect a pressure of the kit part received in the respective receiving points against a mechanical stop as an electrical signal. This allows the correct positioning and/or orientation to be recorded particularly accurately and easily.

The line management system may be connected to a database in which the assigned production order is stored for each of the different product types. This makes it particularly easy for the line management system to access a plurality of production orders. In addition, another line management system of another product container handling plant can also access the database.

The reader may be connected to the machine control via a radio data interface, in particular WLAN or Bluetooth. Thus the reader does not require a wired connection and can therefore be carried particularly easily.

The reader may be connected to a stationary computer system via the radio data interface, wherein the stationary computer system is connected to the machine control via a wired data interface or a radio data interface. Thus, the reader requires particularly little energy to communicate with the machine control via the stationary computer system. However, it is also conceivable that the reader is directly connected to the machine control and/or the line management system via the radio data interface. The radio data interface can be a Bluetooth or WLAN interface, for example.

The machine control, the stationary computer system and/or the line management system may include a CPU, a memory unit, an input/output unit, a computer network interface and/or other computer components. The computer network here may be a data connection via WLAN, Ethernet, OPC UA or similar.

Furthermore, the invention provides a handling method for product containers with the features of claim 11 for solving the object. Advantageous embodiments of the invention are specified in the subclaims.

Since the line management system provides in each case the production order with the configuration list of the at least one container handling machine, the configuration list comprising the selection of interchangeable kit parts intended for the processing of the respective product type, the kit parts required for the respective production order are automatically provided as information. By attaching the reader to the arm or hand of the operator, wherein the reader reads the first identification data from the first data transponders and thereby identifies the selection of interchangeable kit parts provided in the configuration list, the operator can easily identify the selection of interchangeable kit parts provided in the configuration list by reading the first data transponders of the kit parts with the reader. This can be done, for example, with an inventory of at least some of the interchangeable kit parts. As a result, the operator already knows when picking up one of the kit parts from the inventory that it belongs to the intended selection and is therefore required for the corresponding production order. The fact that the reader is attached to the arm or hand of the operator means that the operator can still pick up the kit parts with both hands without having to use the reader in one hand.

The handling process may comprise the features described above in relation to the handling plant, in particular according to any of claims 1-10 individually or in any combination mutatis mutandis. The handling plant may be configured to carry out the handling process described below, in particular according to any of claims 11-14.

The first identification data may be compared with the configuration list by a machine control of the at least one container handling machine in order to check a correct equipping of the at least one container handling machine with the selection of the interchangeable kit parts provided for the respective product type. This makes it particularly easy to check the correct installation of the kit parts.

The receiving points are marked with second data transponders, in particular with second RFID transponders, wherein second identification data are read out from the second data transponders with the reader. This also makes it particularly easy to identify the receiving points with the reader, so that the operator receives information as to whether the respective kit part is intended for the receiving point in the production order.

The production orders may each comprise an assignment list of the selection of the interchangeable kit parts to the corresponding receiving points of the at least one container handling machine provided therefor, wherein, with the machine control, the first identification data and the second identification data are compared with the assignment list in order to check that the receiving points are correctly equipped with the selection of interchangeable kit parts provided for the corresponding product type. This makes it particularly easy to check automatically the correct equipment of the receiving points with the corresponding kit parts.

Further features and advantages of the invention are explained in more detail below with reference to the embodiments shown in the figures, in which:

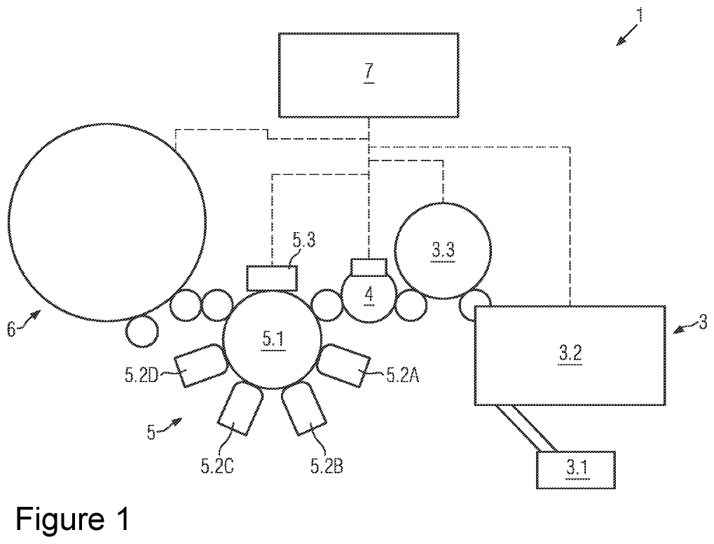

FIG. 1 is an overview of an embodiment of a handling plant for product containers according to the invention;

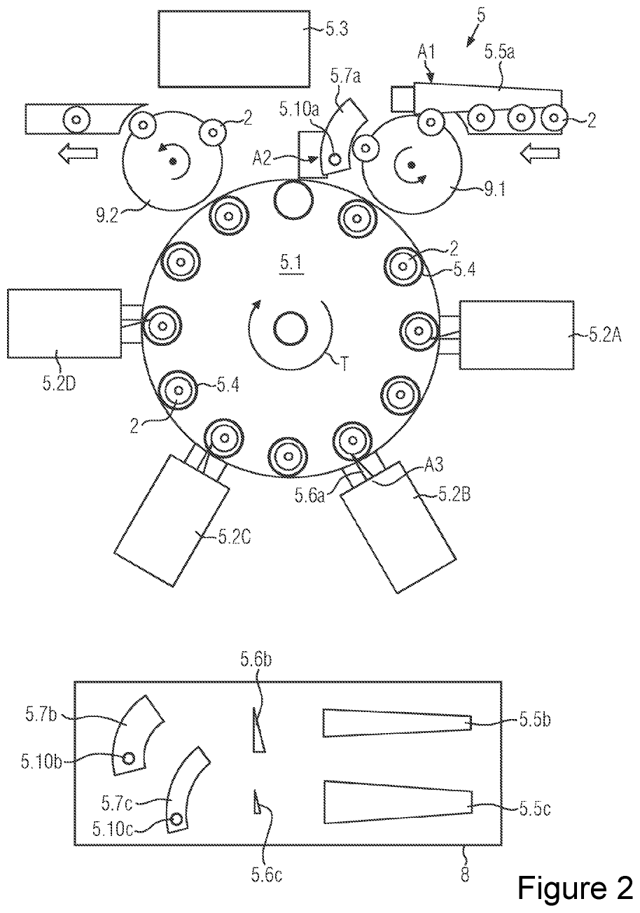

FIG. 2 is a plan view of the labelling machine of the handling plant shown in FIG. 1;

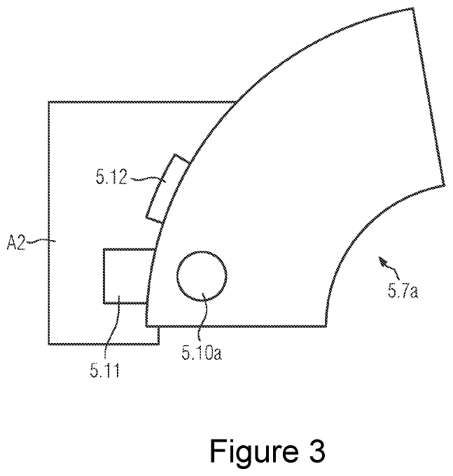

FIG. 3 is a detailed plan view of one of the interchangeable kit parts of the labelling machine shown in FIG. 2; and

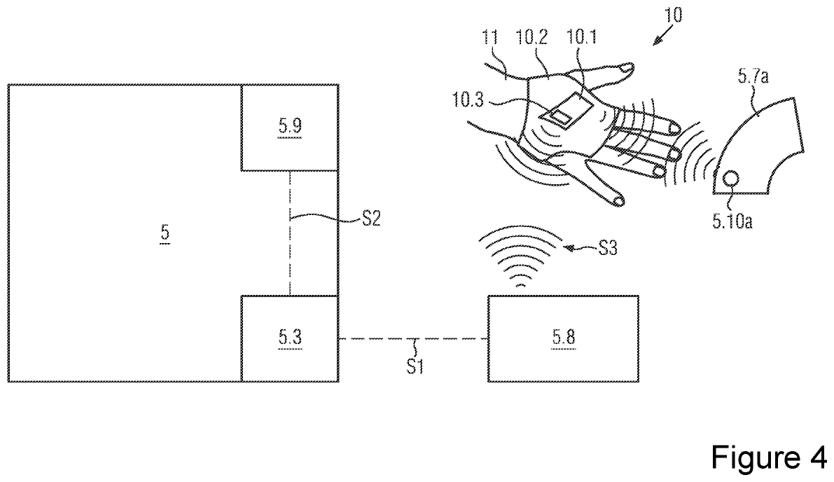

FIG. 4 is a schematic representation of the labelling machine of the handling plant shown in FIG. 1 and the reader that can be attached to the operator's hand.

FIG. 1 shows an overview of an embodiment of a container handling plant 1 for product containers according to the invention. As shown, the handling plant 1 comprises several container handling machines 3-6. These machines are specifically the container production machine 3, the cooling device 4, the labelling machine 5 and the filler 6. The container handling machines 3-6 at least partially are provided with their own conveyors and are connected to each other via further conveyors. It is conceivable that the conveyors are each independently a carousel conveyor, a transport star and/or a linear conveyor.

In addition, the handling plant 1 comprises the line management system 7, which, for processing the different product types, is configured to provide in each case a production order with a configuration list of the container handling machines 3-6, in particular of the labelling machine 5. This is explained in more detail below with reference to FIGS. 2-4. Furthermore, the line management system may be configured as a higher-level control unit for the container handling machines 3-6 in order to coordinate the handling of the product containers. For example, the line management system 7 is configured as a computer system and connected to a database in which the assigned production order is stored for different product types.

The container manufacturing machine 3 comprises an inventory 3.1 for preforms, the oven 3.2 for heating the preforms and the stretch blow moulding unit 3.3 for blow moulding the heated preforms into the finished product containers.

Thereafter, the product containers are cooled down again with the cooling device 4.

The figure shows also the labelling machine 5 with the carousel 5.1 as the conveyor, the labelling units 5.2A-5.2D and the machine control 5.3. The labelling machine 5 is explained in more detail below with reference to FIG. 2.

Furthermore, the filler 6 is shown in which the product containers are filled with a fluid product, for example with a soft drink, beer or wine. The filled containers may then be transported to further container handling machines not shown here, for example to a capper and/or to a packaging machine.

FIG. 2 shows a detailed plan view of the labelling machine 5 of the handling plant 1 shown in FIG. 1. As shown, the product containers 2 are first brought to the required spacing for labelling by the dividing screw 5.5a and then transferred to the conveyor 5.1 via the infeed starwheel 9.1. The handling units 5.2A-5.2D, which are configured here as labelling units, are arranged around the conveyor 5.1. After labelling, the finished product containers 2 are transferred by the starwheel 9.2 to further handling steps, in this case for example to the filler 6 shown in FIG. 1.

The figure shows also that, in order to process different types of product, the labelling machine 5 comprises several interchangeable kit parts 5.5a-5.5c, 5.6a-5.6c, 5.7a-5.7c and receiving points A1-A3 provided for this purpose.

The labelling machine 5 shown in FIGS. 2-4 is only described in more detail below by way of example as a container handling machine with interchangeable kit parts 5.5a-5.5c, 5.6a-5.6c, 5.7a-5.7c. Similarly, at least one of the other container handling machines 3, 4 and/or 6 may also comprise interchangeable kit parts in order to adapt them to the processing of the different types of product. Accordingly, the following explanations apply mutatis mutandis to a container handling machine.

The conveyor 5.1 is configured here as a carousel with the container receptacles 5.4 at regular intervals. The carousel 5.1 rotates in the transport direction T, so that the product containers 2 received in the container receptacles 5.4 are transported to the labelling units 5.2A-5.2D, where the labels are applied. The container receptacles 5.4 are here only provided with a rotary plate and a centering bell as an example, so that the product containers 2 can be rotated relative to the labelling units 5.2A-5.2D during labelling.

The figure shows also the machine control unit 5.3, which is used to control the processes of the labelling machine 5. The machine control 5.3 comprises, for example, a computer system, in particular a CPU, a memory unit, an input and output unit and the like. It is configured to control the conveyor 5.1 and the labelling units 5.2A-5.2D.

The kit parts 5.5a-5.5c are different dividing screws for example. Since different types of containers with different diameters are processed for different types of products, the dividing screw 5.5a can be exchanged for one of the other dividing screws 5.5b or 5.5c located in the inventory 8.

Furthermore, various dispensing edges 5.6a, 5.6b and 5.6c are available for the labelling units 5.2A-5.2D. For example, these are exchanged for different container diameters and/or label types as interchangeable kit parts.

Furthermore, various guide railings 5.7a-5.7c are shown as interchangeable kit parts. These can also be interchanged depending on the container type in order to guide the product containers 2 along the infeed starwheel 9.1.

Only the interchangeable kit parts 5.7a-5.7c are described in detail below. The explanations also apply accordingly to the other interchangeable kit parts 5.5a-5.5c, 5.6a-5.6c or other kit parts of the labelling machine 5 not shown in more detail here.

As shown, the interchangeable kit parts 5.7a-5.7c comprise the first data transponders 5.10a-5.10c with first identification data for identification. The first data transponders 5.10a-5.10c are configured here, for example, as RFID transponders and each have an electronic unit with a memory for the first identification data and with an antenna for receiving and transmitting electromagnetic signals. They can be read by the reader 10 described below with reference to FIG. 4, attached to the hand 11 of an operator, in order to identify the selection of interchangeable kit parts 5.7a-5.7c provided in the configuration list.

As described above, the line management system 7 shown in FIG. 1 is configured to provide a production order with a configuration list for the labelling machine 5 for processing the different product types. The configuration list thus contains a selection of those interchangeable kit parts 5.5a-5.5c, 5.6a-5.6c, 5.7a-5.7c that are required for the corresponding production order.

For example, the line management system 7 may be prompted by an operator to switch to a different type of product. For this purpose, the line management system 7 then provides a production order with a configuration list of the labelling machine 5 with the selection of the interchangeable kit parts 5.5b, 5.6b and 5.7b intended for processing the product type. These are disposed initially in the inventory 8 and must be installed by an operator at the labelling machine 5. They must therefore be exchanged by the operator for the kit parts 5.5a, 5.6a and 5.7a mounted at the receiving points A1-A3.

When changing the guide railings 5.7a-5.7c, the operator identifies the other two guide railings 5.7b and 5.7c in the inventory 8 by reading the corresponding first data transponders 5.10b and 5.10c with the reader 10.

The same applies to the other interchangeable kit parts 5.5a-5.5c and 5.6a-5.6c, each of which also comprises a first data transponder with first identification data not shown here.

Furthermore, the machine control 5.3 is configured to compare the first identification data with the configuration list of the production order in order to preset and/or check a correct equipment of the labelling machine 5 with the selection of the interchangeable kit parts 5.5a-5.5c, 5.6a-5.6c, 5.7a-5.7c of the operator provided for the corresponding product type.

In addition, the configuration list contains an assignment of the selection of the interchangeable kit parts 5.5a-5.5c, 5.6a-5.6c, 5.7a-5.7c to the corresponding receptacles A1-A3 of the labelling machine 5. This makes it particularly easy for the operator to find out which kit part is intended for which of the receiving points A1-A3.

Furthermore, FIG. 3 shows a detailed plan view of one of the interchangeable kit parts 5.7a of the labelling machine 5 from FIG. 2. As shown, the kit part 5.7a comprises the first data transponder 5.10a as described further above. Furthermore, it can be seen that the receiving point A2 comprises the second data transponder 5.11 with second identification data for identification, which can be configured in particular as a second RFID transponder. The reader 10 shown below in FIG. 4 is configured to read the second identification data from the second data transponder 5.11 so that a correct assignment of the kit part 5.7a to the receiving point A2 can be checked by reading the first identification data from the first data transponder 5.10a and the second identification data from the second data transponder 5.11.

Similarly, the receiving points A1 and A3 shown in FIG. 2 also each comprise a second data transponder, not shown here, with second identification data that can be read by the reader 10. This allows the kit parts 5.5a-5.5c or 5.6a-5.6c to be assigned accordingly.

Furthermore, the machine control 5.3 is configured to compare the first identification data and the second identification data with the assignment in order to check a correct equipment of the receiving points A1-A3 with the selection of the interchangeable kit parts 5.5a-5.5c, 5.6a-5.6c, 5.7a-5.7c provided for the corresponding product type.

As shown also in FIG. 3, the receiving point A2 is provided with a sensor 5.12 to detect the presence of one of the interchangeable kit parts 5.7a-5.7c, its correct positioning and/or its correct orientation. The sensor 5.12 is configured here, for example, as a piezoelectric element that detects the pressure of the kit part 5.7a just received at the receiving point A2 against a mechanical stop as an electrical signal. This allows a corresponding load signal to be sent to the machine control 5.3, whereupon the machine control 5.3 compares the load signal with a target value. If it deviates beyond a predetermined limit, an error signal is issued to the operator.

FIG. 4 shows a schematic diagram of the labelling machine 5 of the handling unit 1 shown in FIG. 1 and the reader 10 which can be attached to the hand 11 of the operator.

As shown, the reader 10 comprises a portion of a textile glove 10.2, reading electronics 10.1 and an antenna 10.3 for transmitting and receiving electromagnetic signals. This allows the reader to communicate with the first data transponders 5.10a-5.10c and with the second data transponders 5.11 via the electromagnetic signals and thus read out the first identification data and the second identification data. The reader 10 can be attached to the hand 11 of the operator, for example. It is also conceivable that it can be attached to the arm of the operator, for example with a wristband. This makes the reader 10 particularly easy to carry around without interfering with gripping with the hand 11.

The figure shows also that the reader 10 is connected via a radio data interface S3 to the stationary computer system 5.8, which is connected via a wired data interface S1 to the machine control 5.3 of the labelling machine 5. This allows the stationary computer system to be placed in a suitable location so that as little energy as possible is consumed. Correspondingly, the touchscreen 5.9 is connected to the machine control via the wired data interface S2, so that the configuration list and/or the assignment, for example, can be shown to the operator. The radio data interface S3, the wired data interface S1 and/or the wired data interface S2 operate as a computer network, for example based on an OPC UA standard.

Since the handling plant 1 comprises the line management system 7 which is configured to provide in each case the production order with the configuration list of the at least one container handling machine 3-6 for processing the different types of product, the configuration list comprising the selection of interchangeable kit parts 5.5a-5.5c, 5.6a-5.6c, 5.7a-5.7c intended for the processing of the respective product type, the kit parts 5.5a-5.5c, 5.6a-5.6c, 5.7a-5.7c required for the respective production order are automatically provided as information. The fact that the handling plant 1 comprises the reader 10, which can be attached to the arm or hand 11 of the operator for reading the first identification data from the first data transponders 5.10a-5.10c enables the operator to easily identify the selection of interchangeable kit parts 5.5a-5.5c, 5.6a-5.6c, 5.7a-5.7c provided in the configuration list by reading the first data transponders 5.10a-5.10c of the kit parts 5.5a-5.5c, 5.6a-5.6c, 5.7a-5.7c with the reader 10. This can be done, for example, with the inventory 8 of at least some of the interchangeable kit parts 5.5a-5.5c, 5.6a-5.6c, 5.7a-5.7c. As a result, the operator already knows when picking up one of the kit parts 5.5a-5.5c, 5.6a-5.6c, 5.7a-5.7c from the inventory 8 that it belongs to the intended selection and is therefore required for the corresponding production order. The fact that the reader 10 can be attached to the arm or hand 11 of the operator means that the operator can still pick up the kit parts 5.5a-5.5c, 5.6a-5.6c, 5.7a-5.7c with both hands without having to use the reader in one hand 11.

Thus, the handling plant 1 according to the invention makes it possible to install the interchangeable kit parts 5.5a-5.5c, 5.6a-5.6c, 5.7a-5.7c quickly and reliably.

It is understood that features mentioned in the previously described embodiments according to the invention are not limited to this combination of features, but are also possible individually or in any other combination of features.

1. A handling plant for product containers with
a conveyor for transporting the product containers, and with at least one container handling machine, which comprises a handling unit for handling the product containers, wherein the container handling machine comprises several interchangeable kit parts for processing different product types and receiving points provided therefor, and wherein the interchangeable kit parts comprise first data transponders with first identification data, for identification,
wherein
the handling plant comprises a line management system which, for the processing of the different product types, is configured to provide in each case a production order with a configuration list of the at least one container handling machine, the configuration list comprising a selection of the interchangeable kit parts intended for the processing of the respective product type, and
the handling plant comprises a reader, configured to be attached to an arm or hand of an operator, for reading the first identification data from the first data transponders, in order to identify the selection of interchangeable kit parts provided in the configuration list.

2. Handling plant according to claim 1, wherein the at least one container handling machine comprises a machine control, wherein the machine control is configured to compare the first identification data with the configuration list in order to preset and/or check a correct equipment of the at least one container handling machine with the selection of the interchangeable kit parts of the operator provided for the corresponding product type.

3. Handling plant according to claim 2, wherein the configuration list comprises an assignment of the selection of the interchangeable kit parts to the respective receiving points of the at least one container handling machine provided therefor.

4. Handling plant according to claim 3, wherein the receiving points each comprise second data transponders with second identification data for identification purposes, and wherein the reader is configured to read the second identification data from the second data transponders.

5. Handling plant according to claim 4, wherein the machine control is configured to compare the first identification data and the second identification data with the assignment in order to check the correct equipment of the receiving points with the selection of the interchangeable kit parts provided for the corresponding product type.

6. Handling plant according to claim 3, wherein the receiving points are at least partially configured with a sensor in order to detect in each case the presence of one of the interchangeable kit parts, its correct positioning and/or its correct orientation.

7. Handling plant according to claim 6, wherein the sensor comprises a piezoelectric element for detecting a pressure of the kit part received in the respective receiving points against a mechanical stop as an electrical signal.

8. Handling plant according to claim 1, wherein the line management system is connected to a database in which the assigned production order is stored for each of the different product types.

9. Handling plant according to claim 2, wherein the reader is connected to the machine control via a radio data interface.

10. Handling plant according to claim 9, wherein the reader is connected to a stationary computer system via the radio data interface, and wherein the stationary computer system is connected to the machine control via a wired data interface or the radio data interface.

11. A handling method for product containers, wherein the product containers are transported by a conveyor and are handled by a handling unit of at least one container handling machine, wherein a plurality of kit parts of the container handling machine are exchanged for processing different types of product and are received at receiving points provided for this purpose, the interchangeable kit parts being identified with first data transponders,
wherein
a line management system for processing the different product types provides in each case a production order with a configuration list of the at least one container handling machine, and wherein the configuration list comprises a selection of the interchangeable kit parts intended for processing the respective product type, and in that a reader, is attached to the arm or hand of an operator, the reader being used to read first identification data from the first data transponders and thus to identify the selection of interchangeable kit parts provided in the configuration list.

12. Handling method according to claim 11, wherein the first identification data are compared with the configuration list by a machine control of the at least one container handling machine in order to check a correct equipping of the at least one container handling machine with the selection of the interchangeable kit parts provided for the respective product type.

13. Handling method according to claim 12, wherein the receiving points are marked with second data transponders, and wherein second identification data are read out from the second data transponders with the reader.

14. Handling method according to claim 13, wherein the production orders each comprise an assignment list of the selection of the interchangeable kit parts to the corresponding receiving points of the at least one container handling machine provided therefor, and wherein, with the machine control, the first identification data and the second identification data are compared with the assignment list in order to check that the receiving points are correctly equipped with the selection of interchangeable kit parts provided for the corresponding product type.

15. Handling plant according to claim 1, wherein the first data transponders are first RFID transponders.

16. Handling plant according to claim 1, wherein the reader is an RFID reader.

17. Handling plant according to claim 4, wherein the second data transponders are second RFID transponders.

18. Handling method according to claim 11, wherein the first data transponders are first RFID transponders.

19. Handling method according to claim 11, wherein the reader is an RFID reader.

20. Handling method according to claim 13, wherein the second data transponders are second RFID transponders.
